(19) United States
(12) Patent Application Publication
(10) Pub. No.: US 2010/0034579 A1
(43) Pub. Date: Feb. 11, 2010

(54) BALL JOINTS AND CONNECTION UNIT USING SAME

(75) Inventors: MENG-HUA HE, Shenzhen City (CN); GANG CHENG, Shenzhen City (CN); CHUN-CHE YEN, Tu-Cheng (TW); YU-TAO CHEN, Tu-Cheng (TW); TE-SHENG JAN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/430,053

(22) Filed: Apr. 24, 2009

(30) Foreign Application Priority Data
Aug. 8, 2008 (CN) 200810303598.6

(51) Int. Cl. F16C 11/08; F16C 11/06

(52) U.S. Cl. 403/115; 403/56

(57) ABSTRACT

A ball joint includes a socket housing, a stem portion, and a retaining ring. The socket housing defines a ball socket therein and a ring-shaped groove on an outer surface thereof. The ring-shaped groove surrounds the ball socket. The stem portion comprises a ball. Bumps and concaves are respectively evenly disposed on the surfaces of the ball and the ball socket. The ball rotatably fits in the ball socket. The retaining ring is fit in the ring-shaped groove for keeping the ball in the ball socket. The ball can rotate regularly and can avoid accidentally rotation.

### BACKGROUND

1. Technical Field

The present disclosure relates to a joint and, particularly, to a ball joint, and a connection unit using the ball joint.

2. Description of Related Art

A ball joint includes a socket housing and a stem portion. The socket housing defines a ball socket. The stem portion includes a ball. The ball is rotatably received in the ball socket. Yet, when the ball cannot regularly rotate in the ball socket, the joint cannot maintain an accurate position, thus, un-intended rotation may occur while it should be avoided.

What is needed is a ball joint which can avoid the aforementioned problems.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an exploded view of a ball joint according to an exemplary embodiment.

FIG. 2 is an assembled, isometric view of the ball joint of FIG. 1.

FIG. 3 is a section view of the ball joint of FIG. 2.

FIG. 4 is an isometric view of a connection unit, wherein the connection unit comprises more than one of the ball joint of FIG. 2.

### DETAILED DESCRIPTION

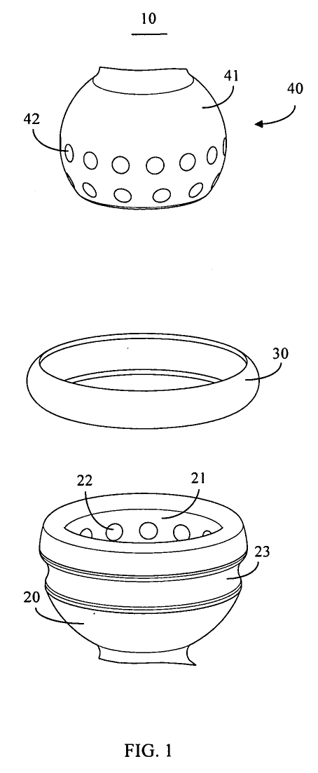

Referring to FIG. 1, a ball joint 10 according to an exemplary embodiment is disclosed. The ball joint 10 is made of a synthetic resin material, which has elasticity and rigidity. The ball joint 10 includes a socket housing 20, a stem portion 40, and a retaining ring 30.

The socket housing 20 is bowl-shaped. The socket housing 20 defines a ball socket 21 therein. The socket housing 20 further defines a ring-shaped groove 23 formed on an outer surface of the socket housing 20. The ring-shaped groove 23 surrounds the ball socket 21. The stem portion 40 includes a ball 41.

A plurality of rows of bumps 22 are evenly disposed on the surface of the ball socket 21. A plurality of rows of concaves 42 are evenly disposed on the surface of the ball 41 and configured for receiving the bumps 22. Alternatively, the bumps 22 are disposed on the ball 41, and the concaves 42 are disposed on the ball socket 21.

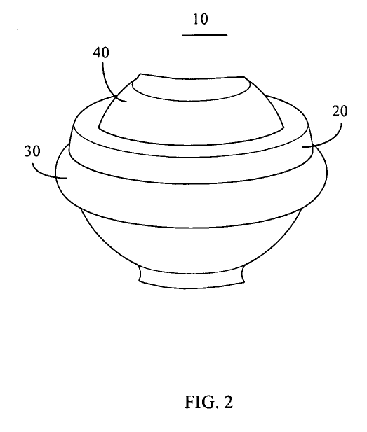

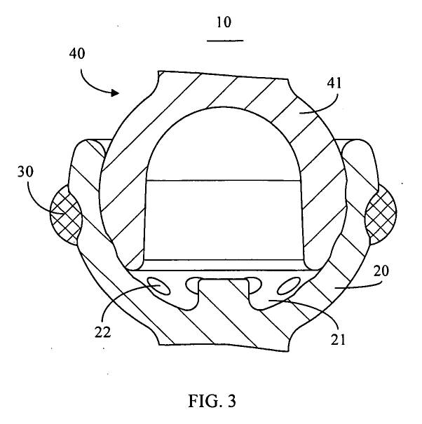

Referring to FIGS. 2 and 3, during assembly of the ball joint 10, the ball 41 is placed in the ball socket 21. The retaining ring 30 is fit in the ring-shaped groove 23 and keeps the ball 41 in the ball socket 21.

When the ball 41 rotates in the ball socket 21, the ball 41 and the ball housing 40 elastically deform, thus allowing the bump 22 to move from one concave 42 to another concave 42. As the bumps 22 and the concaves 42 are disposed evenly, the ball 41 can rotate regularly, and can maintain an accurate position. The cooperation of the bumps 22 and the concaves 42 prevent the ball 41 from accidentally rotating.

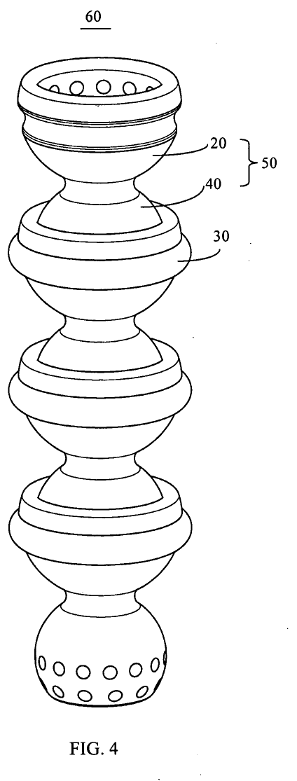

Referring to FIG. 4, each of connection elements 50 includes the stem portion 40 and the socket housing 20. By cooperation of the balls 41 and the ball socket 21, the connection elements 50 are connected to each other end-to-end to form a connection unit 60. The connection unit 60 further includes the retaining rings 30 for keeping the balls 41 in the ball sockets 21. A length of the connection unit 60 can be adjusted conveniently by changing the number of the connection elements 50.

Moreover, it is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A ball joint comprising:
a socket housing defining a ball socket therein and a ring-shaped groove on an outer surface thereof, wherein the ring-shaped groove surrounds the ball socket;
a stem portion comprising a ball, wherein bumps and concaves are respectively evenly disposed on the surfaces of the ball and the ball socket, and the ball rotatably fits in the ball socket with each bump being received in one concave; and
a retaining ring being fit in the ring-shaped groove for keeping the ball in the ball socket.

2. The ball joint of claim 1, wherein the socket housing is bowl shaped.

3. The ball joint of claim 1, wherein the socket housing and the stem portion are made of a synthetic resin material that has elasticity and rigidity.

4. A connection unit comprising:
a plurality of connection elements, each connection element comprising:
a socket housing on an end, wherein the socket housing defines a ball socket therein and a ring-shaped groove on an outer surface thereof, and the ring-shaped groove surrounds the ball socket; and
a stem portion on another end, wherein the stem portion comprises a ball, bumps and concaves are respectively evenly disposed on the surfaces of the ball and the ball socket; and
a plurality of retaining rings corresponding to the plurality of connection elements in number; wherein
each ball rotatably fit in the ball socket of another connection element to connect the connection elements one by one, each retaining ring is fit in the ring-shaped groove of the ball socket of the another connection element to keep the ball in the ball socket.

5. The connection unit of claim 4, wherein the socket housing is bowl shaped.

6. The connection unit of claim 4, wherein the connection element is made of a synthetic resin material that has elasticity and rigidity.
